(19) United States
(12) Patent Application Publication
(10) Pub. No.: US 2020/0381736 A1
(43) Pub. Date: Dec. 3, 2020

(54) DEFECT-FREE GRAPHENE AND METHODS FOR PRODUCING THE SAME

(71) Applicant: Sparkle Power LLC, Rochester, NY (US)

(72) Inventors: David Mitlin, Lakeway, TX (US); Wei Liu, Chengdu (CN)

(21) Appl. No.: 16/798,760

(22) Filed: Feb. 24, 2020

Related U.S. Application Data
(60) Provisional application No. 62/809,131, filed on Feb. 22, 2019.

(51) Int. Cl. H01M 4/62; H01M 2/14; H01M 2/16; H01M 10/0525; H01M 10/054; C01B 32/19

(52) U.S. Cl. CPC H01M 4/628; H01M 2/145; H01M 2/1646; H01M 10/0525; C01P 2004/03; H01M 2/1686; C01B 32/19; C01B 2204/22; H01M 10/054

(57) ABSTRACT

A defect-free graphene and a method of making a defect-free graphene. A method for synthesizing defect-free graphene, the method including providing a graphene precursor to a flow-aided sonication apparatus, the graphene precursor comprised of particulates, wherein the flow-aided sonication apparatus comprises: a flow channel positioned along an axis, the flow channel having a first opening and a second opening, the second opening opposite of the first opening, wherein the graphene precursor enters the flow channel through the first opening; aligning edges of the particulates parallel to axis A; and imposing sonication shockwave to the edges of the aligned particulates of the graphene precursor, wherein the sonication shockwave is imposed to the graphene precursor in a propagation direction perpendicular to the edges of the particulates such that planes of the sonication shockwave are parallel to the edges of the particulates, thereby synthesizing defect-free graphene.

### CROSS-REFERENCE TO RELATED APPLICATIONS

The instant application claims priority to co-pending U.S. Provisional Application No. 62/809,131, filed on Feb. 22, 2019, and entitled “Method for Stabilizing Solid Electroltye Interphase (SEI) and Preventing Dendrites”. The entirety of the aforementioned provisional application is incorporated by reference in its entirety.

### FIELD OF THE INVENTION

The present invention relates to defect-free graphene and method for producing defect-free graphene, and electrodes that include defect-free graphene.

### BACKGROUND OF THE INVENTION

Owing to its unique physical and chemical properties, graphene and graphene-like 2D-materials are attracting world-wide scientific attention. As most important classes of graphene applications will ultimately require scalable production, a series of methods for synthesizing graphene by exfoliating graphite, known as “top-down” approaches, have been established. The top-down methods may be based on sonication, and include “liquid phase exfoliation (LPE)”, “oxidative exfoliation” and “intercalation exfoliation” approaches. To date, it remains a challenge to synthesize graphene with precisely controlled defect content. For instance, by minimizing the introduction of oxidants, reductants or intercalates, LPE can produce graphene with relatively low defect levels. However, the sonication process itself produces unfavorable features in the graphene structure, such as fragmentation, structural and chemical defect formation etc. It is widely recognized that the sonication pulse wave is the main driving force for graphite exfoliation. Broadly speaking, the sonication “cavitation” and “micro-jetting” effect on liquid-solid interfaces is known. However the action of micro-jets on the highly anisotropic graphite precursor remains to be fully understood, especially in regard to the complex LPE process.

The established isotropic sonication (particles are randomly aligned to the pulse) exfoliation process is yet to yield graphene with precisely controlled defect content, such as what would be needed for many scientific studies and technological applications.

Room temperature sodium metal batteries (SMBs) (e.g., Na—S, Na—Se, Na—O₂ and Na-ceramic cathode) have been actively studied as state-of-the-art energy storage applications. Issues regarding S and Se cathodes (e.g. insulating nature of elemental sulfur, polysulfide and polyselenide shuttle) are being addressed by incorporating S or Se in conductive carbon matrices or confining them in carbon sheaths. However, progress on the Na anode side remains at a fairly early stage and more work is needed on both the scientific and the technological aspects. It is also well recognized that dendrite growth is the major impediment towards implementation of metal anodes for both Na and Li batteries. Sodium metal anodes are hampered by somewhat analogous issues as lithium anodes: the electrodeposition of sodium is accompanied by uncontrollable dendrites growth that leads to low Coulombic efficiency (CE) due to solid electrolyte interface (SEI) growth, rapid electrolyte exhaustion, and premature cell failure. The morphology of Na dendrites varies, but is often either “needle-like” or “mossy”. With Na metal, the origin of the dendrites' structure is not established, although it may also be reaction-limited defect-catalyzed analogous to Li dendrites. Over the past several decades, extensive research has been conducted to understand the Li dendrites. Much less work has been performed on the Na metal system, adding a certain level of excitement to Na studies.

An established strategy for reducing dendrite growth is to employ a range of nucleation templates, such as various nanostructured carbons, ceramic particles/architectures, and metals/alloys with considerable chemical/physical interactions with the depositing metal. Confining the depositing metal in the porous conductive host of higher surface area than the actual current collector can enhance the stability of plating/stripping by ensuring homogeneous current flux and accommodating the volume change. Carbon felts, carbonized wood, and graphene foam have been explored. Improved electrochemical performance may also be attributed to the large surface area of the scaffold structure, which impedes the initial dendrite growth by reducing the real current density on the material.

The presently described invention identifies and addresses graphene defectiveness, which provides insights regarding the use of graphene as electrodes for sodium and lithium ion batteries (SIBs, LIBs).

### SUMMARY

In one embodiment, the present invention employs graphene with tuned structure and chemistry to quantitatively examine the role of graphene defectiveness on Na metal plating near 0 V vs. Na/Na⁺. The invention and related disclosure is different from prior studies, where defective graphene was employed as the actual anode for sodium and lithium ion batteries (SIBs, LIBs), with typical voltage ranges being 2.5-0.01 V. In the present invention, it is demonstrated that graphene defects are actually quite deleterious for efficient Na plating and stripping near 0 V vs. Na/Na⁺. At cycle 1, the defective graphene demonstrates much more copious solid electrolyte interphase (SEI) formation. The SEI then yields more extensive capacity loss during subsequent Na plating/stripping by promoting unstable dendritic growth.

In one embodiment, the present invention is directed to a directional flow-aided sonochemistry (FAS) exfoliation technique that allows for unparalleled control of graphene structural order and chemical uniformity.

In one embodiment, the present invention is directed to a stabilization material for an energy storage device, the material comprising: defect-free graphene. In one embodiment, the defect-free graphene has a maximum O content of 2 at. %. In one embodiment, the defect-free graphene has a maximum O content of 1.3 at. %. In one embodiment, the defect-free graphene has up to three layers. In one embodiment, the defect-free graphene has 3 layers; has 2 layers; has 1 layer. In one embodiment, the defect-free graphene has a Raman G/D band intensity ratio of at least 10; in one embodiment the defect-free graphene has a Raman G/D band intensity ratio of 14.3. In one embodiment, the material is applied to an electrode or a separator of the energy storage device. In one embodiment, the material is applied to the separator. In one embodiment, the electrode is an anode or a cathode. In one embodiment of the stabilization material according to claim 1 more than 50% of the defect-free graphene has a thicknesses less than 2.5 nm, specifically more than 80% of the defect-free graphene has a thickness less than 2.5 nm. In one embodiment, the stabilization material comprises 100% defect-free graphene; at least 80% defect-free graphene; at least 70% defect-free graphene; at least 50% defect-free graphene.

In another embodiment, the present invention is directed to a method of stabilizing an energy storage device, the method comprising: providing an energy storage device comprising at least one electrode and a separator; and applying a stabilization material according the above-described material to an electrode or a separator, wherein the stabilization material is applied in an amount sufficient to: prevent or minimize dendrite formation or growth during cycling; stabilize an electrode/electrolyte interphase; or stabilize solid electrolyte interphase (SEI). In one embodiment, the stabilization material is applied to the separator. In one embodiment, the stabilization material is applied to the electrode, wherein the electrode is a cathode or an anode.

In one embodiment, the invention is directed to a method for synthesizing defect-free graphene, the method comprising: providing a graphene precursor to a flow-aided sonication apparatus, the graphene precursor comprised of particulates, wherein the flow-aided sonication apparatus comprises: a flow channel positioned along an axis, the flow channel having a first opening and a second opening, the second opening opposite of the first opening, wherein the graphene precursor enters the flow channel through the first opening; aligning edges of the particulates parallel to the axis; and imposing sonication shockwave to the edges of the aligned particulates of the graphene precursor, wherein the sonication shockwave is imposed to the graphene precursor in a propagation direction perpendicular to the edges of the particulates such that planes of the sonication shockwave are parallel to the edges of the particulates, thereby synthesizing defect-free graphene.

The method for synthesizing may include, in one embodiment, suspending the graphene precursor in a solvent. In one embodiment the solvent is N-methyl pyrrolidone.

In an embodiment of the method for synthesizing, the graphene precursor is selected from the group consisting of graphite, hemp and cannabis. In one example, the graphite is graphite powder.

In an embodiment of the method for synthesizing, the sonication shockwave is imposed for between 0.001 second to 3 seconds per each flow cycle; a least 3 seconds for each flow cycle; at least 2 seconds for each flow cycle; at least 1 second for each flow cycle; at least 0.5 second for each flow cycle; at least 0.25 second for each flow cycle; at least 0.10 second for each flow cycle; at least 0.02 second for each flow cycle; at least 0.01 second for each flow cycle; at least 0.024 s for each flow cycle.

The method for synthesizing further includes, in an embodiment, collecting the graphene precursor and defect-free graphene exiting the second opening of the flow channel; centrifuging the collected graphene precursor and defect-free graphene; and isolating the defect-free graphene from the graphene precursor.

Another embodiment is directed to a defect-free graphene synthesized by the aforementioned process. In one embodiment, the defect-free graphene comprises a maximum heteroatom content of 2 at. %.

Another embodiment is directed to an electrode comprising a defect-free graphene. In one embodiment, the defect-free graphene is synthesized in accordance with the aforementioned method. In one embodiment of the electrode, the defect-free graphene stabilizes solid electrolyte interphase (SEI) growth on a surface of the electrode.

Another embodiment of the method for synthesizing defect-free graphene includes providing a graphene precursor to a flow-aided sonication apparatus, the graphene precursor comprised of particulates, wherein the flow-aided sonication apparatus comprises: a flow channel positioned along an axis, the flow channel having a first opening and a second opening, the second opening opposite of the first opening; a convergent-slit positioned in the flow channel between the first opening and the second opening; wherein the graphene precursor enters the flow channel through the first opening, proceeds through the convergent slit in a manner such that edges of the particulates are aligned in the convergent slit and parallel to axis A, and the aligned particulates of the graphene precursor pass through the convergent slit and exit through the second opening; and imposing sonication shockwave to the edges of the aligned particulates of the graphene precursor in the convergent slit, wherein the sonication shockwave is imposed to the graphene precursor in a propagation direction perpendicular to the edges of the particulates such that planes of the sonication shockwave are parallel to the edges of the particulates, thereby synthesizing defect-free graphene.

A further embodiment is directed to an electrode comprising a defect-free graphene, the defect-free graphene comprising a maximum O content of 2.0 at. %.

It is contemplated that any of the foregoing embodiments can be combined in any manner suitable.

### BRIEF DESCRIPTION OF THE DRAWINGS

FIG. 1 is an exemplary energy storage device.

FIG. 2 is a front perspective view of a flow-aided sonication (FAS) apparatus according to embodiments described herein.

FIG. 2A is an illustration of detail 2A shown in FIG. 2.

FIG. 3 is a schematic illustration of the FAS exfoliation process using in-plane sonication (IPS) and at-edge sonication (AES).

FIG. 3A is a schematic illustration of a sonication shockwave imposed in a parallel direction to the edges of graphene precursor particulates to obtain df-G.

FIGS. 4(A), 4(B), 4(D), 4(E), 4(G), 4(H) show top-down SEM micrographs of electrode surfaces.

FIGS. 4(C), 4(D), 4(I) are schematics showing SEI formation.

FIG. 5(A) is an AFM image and corresponding height profile of flakes deposited on mica; FIGS. 5(B), 5(C), 5(D) are representative AFM images of individual flakes, with height profile shown below each image. FIGS. 5(E) and 5(F) are AFM derived histograms of width and thicknesses of approximately 100 AES-G flakes. FIG. 5(G) is a TEM micrograph of several graphene flakes; FIG. 5(H) is a representative SAED pattern in the [0001] ZA. FIG. 5(I) is a HRTEM micrograph of a single graphene flake's slightly bent edge with lattice fringes being visible; FIG. 5(J) is a FFT filtered HRTEM micrograph showing a C—C bond length of 0.14 nm.

FIGS. 6(A)-(F) illustrate cycling charge—discharge behavior and the corresponding impedance rise of AES-G (FIG. 5(A)-(C)) and IPS-G (5(D)-(F)) tested in the high voltage range 2.5-0.01 V vs. Na/Na⁺, at 30 mA/g.

FIGS. 7(A)-7(L) are voltage profile and CE during plating/stripping cycles.

FIGS. 8(A), (B), (D), (E), (G), (H) are top-down SEM micrographs of the post-100 cycles electrode surfaces in the fully plated condition.

FIGS. 8(C), (F), (I) are schematics of SEI formation.

### DETAILED DESCRIPTION OF THE INVENTION

The following acronyms may be used throughout the application: df-G—defect-free graphene; r-GO—conventional reduced graphene oxide; GO—graphene oxide; LPE—liquid phase exfoliation; AES-G—at-edge sonication graphene; AES—at-edge sonication; IPS-G—in-plane sonication graphene; IPS—in-plane sonication; FAS—flow-aided sonication; XPS—x-ray photoelectron spectroscopy; CE—Coulombic efficiency; SEI—solid electrolyte interphase; SIB—sodium ion battery; LIB—lithium ion battery; TEM transmission electron microscopy; AFm—atomic force microscopy; SEM—scanning electron microscopy; LMB—lithium metal battery; FEC—fluoroethylene carbonate; HRTEM—high resolution TEM; EIS—electrochemical impedance spectroscopy; DEC—diethyl carbonate; EC—ethylene carbonate; EMC—ethyl methyl carbonate.

Graphene has many applications including, for example, use in energy storage devices. In one application, graphene can be employed in an electrode in a battery. In particular, graphene is plated on electrodes used in batteries. Conventionally, reduced graphene oxide (r-GO) has been utilized in various applications, e.g., in energy storage devices. However, r-GO has been found to have defects, such as heteroatoms, nanopores, vacancies, topological defects, and the like. R-GO, which is prepared by known graphene synthesis methods, such as, e.g., the Hummer method, demonstrate rapidly degrading Coulombic efficiency (CE) and extensive dendrites when used in electrodes of energy storage devices. In contrast, the inventors have surprisingly found a novel method to synthesize defect-free graphene (df-G), which promotes stabilization of solid electrolyte interphase (SEI) growth in energy storage devices. By stabilizing SEI growth, lithium (Li) dendrite formation is reduced or prevented, which improves extended charge-discharge cycling in energy storage devices.

In one embodiment, the present invention is directed to a stabilization material 10 for an energy storage device 12. The term “material” encompasses a substance that can function as a coating, a barrier, a membrane, a support, or a template for an energy storage device 12. In one embodiment, the material 10 includes defect-free graphene. In one embodiment, the defect-free graphene includes a maximum O content of 2.0 at. %. In one embodiment, the defect-free graphene includes a maximum O content of 1.3 at. %. It is contemplated that the defect-free graphene has any O content up to 2.0 at. %, i.e., between 0.0 at. % up to and including 2.0 at. % and any range or value therebetween.

The defect-free graphene has, in one embodiment, a Raman G/D band intensity ratio of at least 10. In one embodiment, the defect-free graphene has a Raman G/D band intensity ratio of 14.3. It is contemplated that the defect-free graphene can have other Raman G/D band intensity ratios of at least 10.

In one embodiment of the material 10, it is contemplated that all of the material, i.e., 100% of the material, is made up of defect-free graphene, i.e., the material 10 comprises 100% defect-free graphene. In another embodiment, the material 10 comprises at least 80% of the defect-free graphene. In another embodiment, the material 10 comprises at least 50% of the defect-free graphene. The invention is not limited in this regard as the material 10 can include any amount of defect-free graphene, i.e., at least 1% of defect-free graphene. When the material 10 includes at least 1% of defect-free graphene, the remainder of the material 10 includes, e.g., conventional graphene, carbon containing material, and/or other materials or additives useful as a material 10 in energy storage devices.

In one embodiment of the material 10, more than 50% of the defect-free graphene has a thicknesses less than 2.5 nm, specifically more than 80% of the defect-free graphene has a thickness less than 2.5 nm.

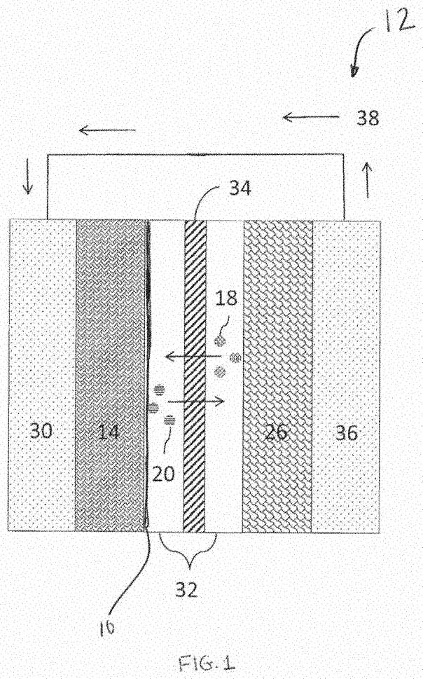

As shown in FIG. 1, in one embodiment, the energy storage device 12 includes at least one electrode, e.g., a cathode 14 and an anode 26. The energy storage device 12 in FIG. 1 also includes a current collector 30, an electrolyte 32, a separator 34, a current collector 36 and circuit flow elements 38. As is understood, the cathode 14 adsorbs ions 18, 20.

The electrolyte may be organic, ionic liquid, aqueous, or a combination. Standard battery and supercapacitor electrolytes are contemplated. Separator 34 may be in accordance with standard battery separators. Current collectors 30, 36 are also in accordance with standard battery collectors.

As shown in FIG. 1, the stabilization material 10 can be applied to an electrode, e.g., a cathode 14. However, the invention is not limited in this regard as the material 10 can be applied to the anode 26 or the separator 34. It is contemplated that the material 10 can be applied to more than one portion of the energy storage device 12. The term “applied” encompasses all modes or variations that allow the material 10 to coat, plate, be adjacent to, impregnate, integrate, or otherwise be a part of the energy storage device 12. The material 10 can be applied to a portion of, e.g., an electrode or a separator, or applied to an entire surface of e.g., an electrode or a separator.

The material 10 can stabilize the energy storage device 12 by preventing or minimizing dendrite formation or growth during cycling, stabilizing an electrode/electrolyte interphase, and/or stabilizing solid electrolyte interphase (SEI). A method to stabilize an energy storage device includes applying, via any known technique suitable, a stabilization material 10 to an electrode 14, 26 or a separator 34.

In one aspect, the present invention provides a defect-free graphene. A defect-free graphene does not include, or has a reduced amount (compared to r-GO) of, heteroatoms, nanopores, vacancies, and topological defects. In one embodiment, the defect-free graphene has a heteroatom content of 1.3 at. % or less. Broadly speaking, heteroatoms are atoms that are not carbon or hydrogen. Typical heteroatoms include, e.g., nitrogen, oxygen, sulfur, phosphorus, chlorine, bromine, and iodine. In one embodiment, the defect-free graphene comprises a maximum O content of 1.3 at. % and a Raman G/D band intensity ratio of 14.3. In one embodiment, the defect-free graphene has a thicknesses less than 2.5 nm, specifically more than 80% of the defect-free graphene has a thickness less than 2.5 nm.

The defect-free graphene may be monolayer or multilayer. In one embodiment, the defect-free graphene includes 3 layers. In one embodiment, the defect free graphene includes 2 layers. In one embodiment, the defect free graphene includes 1 layer.

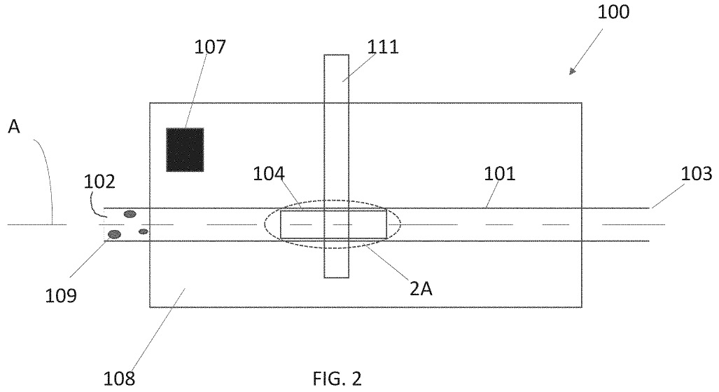

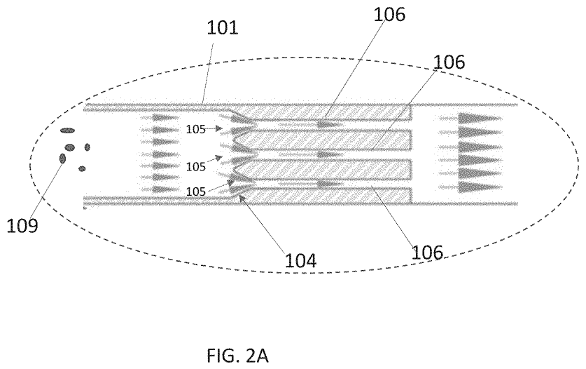

In one aspect of the invention, defect-free graphene is synthesized by a method that includes sonication. As shown in FIG. 2, the method is conducted in a flow-aided sonication apparatus 100. The flow-aided sonication apparatus 100 includes a flow channel 101 that is parallel to an axis A. The flow channel 101 includes a first opening 102 and a second opening 103. In one embodiment, the apparatus 100 includes a convergent-slit 104 is positioned in the flow channel 101 between the first opening 102 and the second opening 103. The detail of the convergent slit 104 is shown in detail 2A, which is enlarged and illustrated in FIG. 2A. As shown in FIG. 2A, the convergent slit 104 includes a plurality of flow mouths 105. Each flow mouth 105 is adjacent a respective conduit 106. While three (3) flow mouths 105 and three (3) conduits 106 are illustrated in FIG. 2A, the flow-aided sonication apparatus 100 is not limited in this regard as one or more flow mouth/conduit combinations can be employed.

In one embodiment, the flow-aided sonication apparatus 100 further includes a thermocouple 107 and/or a pump (not shown). The apparatus 100 includes a water bath 108.

In a method to synthesize defect-free graphene, a graphene precursor 109 is provided to the apparatus 100. As shown in FIG. 2, the graphene precursor 109 is provided to the flow channel 101. The flow channel 101 is in communication with the pump (not shown) to drive the flow of the graphene precursor 109 through the flow channel 101. Any type of graphene precursor can be used. In one embodiment, the graphene precursor 109 is comprised of particulates, e.g., flakes having edges and surfaces, i.e, a top and a bottom surface. Examples of graphene precursors include, but are not limited to graphite, hemp, cannabis, and combinations thereof. In one embodiment, the graphene precursor 109 is graphite powder, e.g., graphite flakes. In one embodiment, the graphene precursor 109 is suspended in a solvent. In a particular embodiment, the graphene precursor is graphite powder, which is suspended in a solvent. Any solvent acceptable to graphene synthesis can be utilized. In one embodiment, the solvent is N-methyl pyrrolidone (NMP). In a particular embodiment, the graphene precursor is graphite powder, which is suspended in NMP.

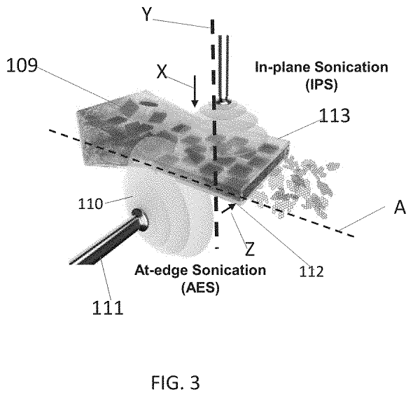

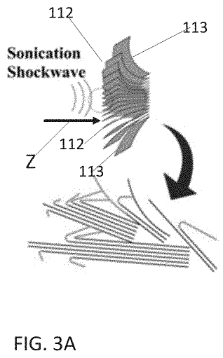

The graphene precursor 109 enters the flow channel 101 through the first opening 102, proceeds through the convergent slit 104 in a manner such that edges of the particulates of the graphene precursor 109 are aligned in the convergent slit 104 and parallel to axis A. The aligned particulates of the graphene precursor 109 pass through the convergent slit 104 and exit through the second opening 103. Disc-like particles are prone to align along the flow with respect to the strain velocity distribution due to elongation or/and shear strain. The suspended particulates in the graphene precursor 109 can be induced to align along the flow with respect to the slit geometry when flowing through the convergent slit 104. In one embodiment, the particulates in the graphene precursor 109 are aligned such that edges of the particulates are parallel to the axis A (see FIGS. 3 and 3A).

As the graphene precursor 109 is pumped into the apparatus 100 and through the flow channel 101 to the convergent slit 104, a sonication shockwave 110 (FIG. 2) is imposed by a sonication probe 111. The sonication shockwave 110 is imposed to the aligned particulates of the graphene precursor 109 in the convergent slit 104. The sonication shockwave 110 is imposed to the graphene precursor 109 in a propagation direction Z that is perpendicular to the edges of the particulate direction perpendicular to the edges of the particulates such that planes of the sonication shockwave are parallel to the edges of the particulates, i.e., the propagation direction Z is perpendicular to the particulate edge and the energy of the sonication shockwave 110 is focused on separating the planes of the particulate apart, thereby synthesizing defect-free graphene, which is referred to as At-Edge Sonication, which results in At-Edge Sonication Graphene (AES-G) or df-G.

In an embodiment of the method for synthesizing, the sonication shockwave is imposed for less than 60 seconds per each flow cycle. In one embodiment, the sonication shockwave is 110 is between 0.001 second to 3 seconds per each flow cycle; a least 3 seconds for each flow cycle; at least 2 seconds for each flow cycle; at least 1 second for each flow cycle; at least 0.5 second for each flow cycle; at least 0.25 second for each flow cycle; at least 0.10 second for each flow cycle; at least 0.02 second for each flow cycle; at least 0.01 second for each flow cycle. In one embodiment, the sonication shockwave 110 is imposed for 0.024 s for each flow cycle.

In the synthesis of AES-G, the sonication shockwave 110 is parallel to the edges 112 of the graphene precursor 109 particulates, (FIGS. 3 and 3A). In FIG. 2, the sonication probe 111 is positioned such that when the sonication shockwave 110 is imposed in a propagation direction Z that is perpendicular to the edges 112 of the graphene precursor 109 particulates in the convergent slit 104 it separates the planes of the particulates apart. As shown in FIG. 2, a sonication shockwave can be applied in a propagation direction X along an axis Y such that it is imposed perpendicular to a surface 113 of the particulates instead of the edges 112. This is referred to as In-Plane Sonication (IPS), which, as detailed in the Examples herein, results in graphene that contains defects (referred to as “IPS-G”).

The method for synthesizing df-G further includes collecting the graphene precursor 109 and defect-free graphene that exits together at the second opening 103 of the flow channel 101. The collected graphene precursor and defect-free graphene is centrifuged to isolate the defect-free graphene from the graphene precursor. The df-G can then be used in acceptable applications, such as, e.g., in an electrode of an energy storage device. When used as or on an electrode, the df-G stabilizes solid electrolyte interphase (SEI) growth on a surface of the electrode.

The formation of a solid electrolyte interphase (SEI) is the irreversible reduction and chemical decomposition of the electrolyte in contact with the anode. Electrochemically, SEI formation is manifested as irreversible capacity loss and impedance rise at voltages below approximately 1 V Li/Li⁺. This means that when a lithium metal battery is charged, SEI formation occurs even before plating begins. SEI formation process involves reduction of the solvent molecules to Li₂O or Li₂CO₃, Li alkyl carbonates and Li alkoxides, all of which irreversibly consume active Li. The reported early (e.g. cycle 1-3) Coulombic efficiency (CE) values for a wide range of carbon materials is often lower than 50%. It is also recognized that structural and chemical defects in a carbon will catalyze SEI formation on its surface. For instance, when more disordered graphitic carbons were tested as lithium ion battery (LIB) anodes, the CE loss and impedance rise at cycle 1 was worse. Also, SEI was recently found to be thicker at the heteroatoms sites in a nitrogen-doped carbon.

The inventors tested df-G and r-GO between 3-0.01 V vs. Li/Li⁺. This corresponds to a typical lithium ion battery (LIB) anode testing protocol, with the lower voltage cutoff being above the equilibrium Li plating potential. The tests were to compare intrinsic SEI formation on df-G and r-GO, without the influence of plated Li metal-electrolyte interaction that would drive additional extensive SEI growth. Galvanostatic results for carbon Li/Li⁺ half-cells indicate that df-G and r-GO possess distinctly different “high voltage” SEI formation properties: The first cycle irreversible capacity loss of r-GO reached 1863 mA/g, whilst that of df-G was only at 148 mAh/g. This initial capacity loss is primarily due to SEI formation on the carbon surfaces. Moreover, the ongoing cycling behavior df-G and r-GO is very different, with distinct voltage profiles. The df-G has a reversible capacity of 525 mAh/g, which is almost half that of r-GO. The difference in the shapes of the voltage profiles is synonymous with Li being reversibly stored in structural and heteroatom defects in r-GO, while intercalation being favored in df-G. The inventors have found that the CE in df-G is quickly stabilized with cycling, going from 78% at cycle 1 to near 100% at cycle 2 and afterward. Conversely the cycling CE for r-GO is 35% at cycle 1, with CE never going above 95% in the first 10 cycles. This indicates that the SEI layer on the much more defective r-GO remains unstable, an observation for explaining the 0 V Li/Li⁺ plating performance.

For Li ion storage, electrochemical impedance spectroscopy (EIS) tests were conducted at terminal lithiation voltage at cycle 1. Df-G exhibits impedance behavior that is well fit by a single arc model. However, a double arc impedance model is needed to fit the Nyquist plots for r-GO. This key difference is attributable to the much higher SEI-related surface film impedance (R_{SEI}) of r-GO, which is large enough to be distinguishable from the charge transfer resistance (R_{CT}).

The plating/stripping voltage profiles for the df-G, r-GO were compared, and bare Cu foil which was used as a baseline. Current densities of 2 mA/cm² and 30 min deposition time were adopted, corresponding to capacity of 1 mAh/cm² at each plating/stripping cycle. Copper foil covered by df-G demonstrates far superior plating/stripping cycle stability among the three systems. The voltage profiles for df-G remain relatively stable throughout the test regime. Conversely, with r-GO severe voltage fluctuations are present after 3000 min of cycling. Voltage fluctuation instability, indicative of an unstable Li metal front, occur with the baseline bare Cu as well. Occasional voltage drops were observed in r-GO and with Cu, which may be ascribed to intermittent “soft-shorts” leading to mixed electronic-ionic conduction. Once more SEI has grown, the fine dendrites would lose their electrical conductivity path due to the associated volume changes, and the system would go back to pure ionic conduction through the electrolyte.

It is known that FEC will have a positive effect on Li metal cycling efficiency by stabilizing the surface morphology. This is directly correlated with the SEI structure. With FEC, the SEI layer on Li surface was more mechanically stable and more effective in suppressing further parasitic reactions, leading to a more uniform and compact Li deposit. Due to the higher reactivity of FEC, greater amounts of LiF and LixPFy, as well as higher portion of the reduction products of cyclic carbonate or polycarbonate species are present in the SEI. Significantly improved CE was observed for the bare Cu electrode with FEC as compared to Cu without it. To be effective, FEC has to be incorporated into the SEI. If more SEI continues to grow, the limited amount of FEC in the electrolyte (5 vol. %, representative of most studies) will become depleted. With r-GO, since SEI growth is ongoing, FEC exhaustion is likely to be the case as well.

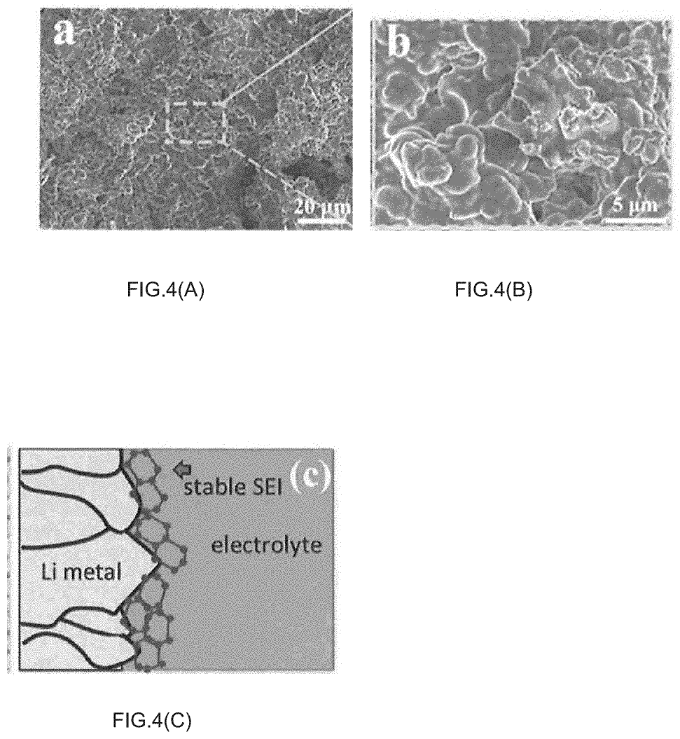

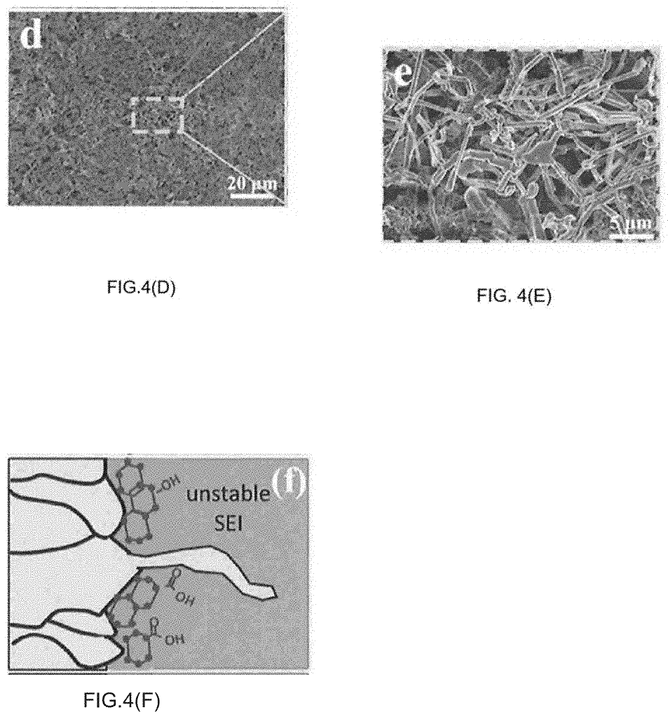

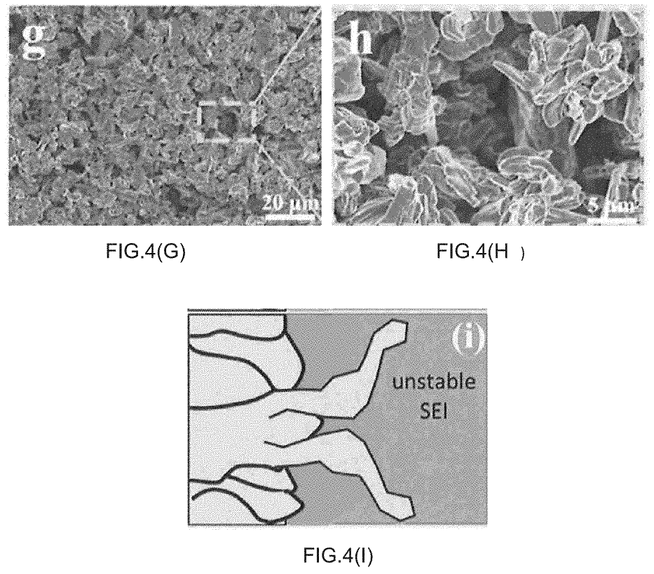

FIG. 4(A)-(I) show top-down SEM micrographs after the samples have underwent 100 cycles, showing the materials in the plated state. Li metal deposited on the bare Cu foil is shown in FIGS. 4(G) and (H). Coarse filament-like dendrite morphologies with branches having diameters of several microns are observed, being consistent with previous studies on bare Cu. Li metal deposition on geometrical perturbances and defects in the Cu current collector will initiate non-planar growth. The geometric and chemical heterogeneity of the pre-existing SEI layer on the Cu will further amplify the Li front growth instability. The role of the graphene chemical and structural defectiveness in promoting stable Li plating is further shown by comparing FIGS. 4(A) and 4(B) for df-G versus FIGS. 4(D) and 4(E) for r-GO. FIGS. 4 (C), 4(F), and 4(I) show schematic cross-sections of the post-cycled electrodes. The df-G specimen exhibits relatively uniform Li metal topography, while that of r-GO is classically dendritic with numerous filament-like dendrites taken as synonymous with tip growth.

The Li accessible surface area in df-G and r-GO electrodes should be sufficient to promote dense metal nucleation in both cases. Therefore, the tremendous difference in plating/stripping behavior and in the post-cycled electrode surfaces is not just an effective current density issue. The difference in the two graphenes is their structural and chemical defectiveness which correlates to their intrinsic propensity to grow SEI. For the Li to plate on any electrically conductive current collector, it first has to ionically diffuse through the electrically insulating SEI layer. A thicker and potentially less homogeneous SEI will lead to non-uniform Li ion conduction through it. The Li ion flux will vary according to SEI phase and local thickness, selectively depositing metal on “hot-spots” to form protrusions. With cycling, these protrusions will advance by tip growth (likely) through the path of least resistance within the heterogeneous SEI. That is, both the Li ions going in and the Li metal going out will be non-uniform. The SEI-growth driven exhaustion of the FEC additive would make this effect worse, leading to self-amplification in the instability of the Li interface for the r-GO and Cu specimens. On the contrary, the initially thinner SEI formed on df-G remain stable during cycling since the FEC added to the electrolyte would not be exhausted. A lower cathodic overpotential with df-G during cycling means that there is a lower nucleation barrier with this host. A classic result of nucleation thermodynamic analysis is that an increased nucleation barrier energy favors heterogeneous nucleation. This means that the observed higher overpotential in r-GO due to more severe SEI formation will intrinsically promote less uniform Li deposition per se.

It is important to point out that while the defective r-GO might be unfavorable from a Li metal plating perspective, it is still highly useful as a primary Li ion storage anode. For example, if one were to set a cut off 30 or 40 mV vs. Li/Li, then metal plating will no longer be thermodynamically favorable. The specific capacity of the r-GO electrode will then far exceed that of defect-free graphene (df-G). In that regard, various forms of reduced graphene oxide and similarly defective carbons are still highly advantageous as anode materials for Li-ion batteries.

The foregoing embodiments, as well as others, are exemplified and further illustrated in the Examples below. The Examples are merely included as illustrations of certain embodiments of the invention and are not meant to limit the scope of the invention as it is described herein.

### Examples

### 1. Preparation and Comparison of AES-G and IPS-G

I. Graphene Synthesis

A route to synthesize graphene with tunable structure is employed that utilizes the rheological behavior of suspension fluid and ultrasound cavitation shockwave effect. In a representative synthesis run, graphite/N-methyl-pyrrolidone (NMP) suspension was driven by a peristaltic pump to circulating flow through the in-house built flow-aided sonochemistry (FAS) apparatus, which consists of a convergent slit 104 that includes three parallel slits being set with respect to the flow direction, as shown in FIG. 2.

Governed by a group of dimensionless parameters (Reynolds number Rₑ, Peclet number Pₑ, etc.), graphite particulates, e.g., flakes or platelets, can be induced to align with respect to the flow geometry as a result of liquid shear. Simultaneous to the flow-induced orientation of graphite platelets, a sonication probe was used to impose shockwaves to the oriented suspension.

Precursor graphite was flat rounded flake with its basal (0002) plane being the wide dimension. As shown in FIGS. 3 and 3A, IPS-G is produced by a sonication shockwave vector normal to its wide face, while AES-G is produced by the shockwave that is propagated in a direction Z that is perpendicular to the edge 112 such that the shockwave is parallel to the flake's edge 112. After a period time of FAS treatment, the suspension was centrifuged to isolate exfoliated graphene from the remnant graphite precusor. The resultant graphene in the supernatant is labeled At-Edge Sonication Graphene (AES-G) and In-Plane Sonication Graphene (IPS-G), denoting the orientation of the incoming shockwave relative to the graphene flakes which have the basal plane in the wide dimension.

II. Analytical Characterization and Structure of Graphene

Atomic force microscopy (AFM) analysis was carried out in tapping mode using a Bruker Multimode 8 AFM. To make the AFM specimens, a drop of graphene ink was drop cast onto freshly cleaved mica substrate. X-ray photoelectron spectroscopy (XPS) was performed employing a ThermoFisher EScalab 250Xi XPS system, with Al Kα radiation. Peak fitting was done using mixed Gaussian/Lorentzian peak shapes after subtraction of Shirley background. Raman spectroscopy was performed using a Horriba LabRAM HR, equipped with a 532 nm laser. Scanning Electron Microscopy analysis was performed using a JSM-7500F Field Emission SEM operated at 15 kV. TEM analysis was performed using a Tecnai G2-F20 operated at 200 kV. Fourier filter of HRTEM images were adopted to give near-atomic resolution. TEM samples were prepared by pipetting several drops of the graphene dispersion onto a lacey carbon mesh grid.

The difference in the sonochemistry orientation resulted in distinct features on the graphite surfaces. This is evident in the SEM/AFM images, as well from the extracted AFM line-scan height profiles. After AES treatment, the morphology of the sedimented graphite precursors indicated delamination of layered structure, as sliding of the graphene layers can be concluded from the small (10-20 nm) steps at the edge of the treated graphite. “Dog-ears”, i.e. local graphene layer folding at the edges, were observed by SEM (arrowed with zoom-in insets in FIG. 1a) and in the AFM profiles, with the blue line scan showing a series of 5 nm steps. This may be due to possible insertion of solvent molecules as a result of the micro-jets. However, this scenario only took place at the near-edge regions, as most of the graphite surface was still flat. By contrast, the IPS treated graphite showed rather coarse surfaces with the presence of much larger steps up to 100-200 nm and higher roughness. The IPS treated graphite also shows pits and cracks which may be observed by SEM and AFM. Examination of IPS treated graphite surfaces gives indication of the punching effect of micro-jets, which are impinging on the (0002) basal plane normal. In contrast to the AES treated graphite, no dog-ears were observed.

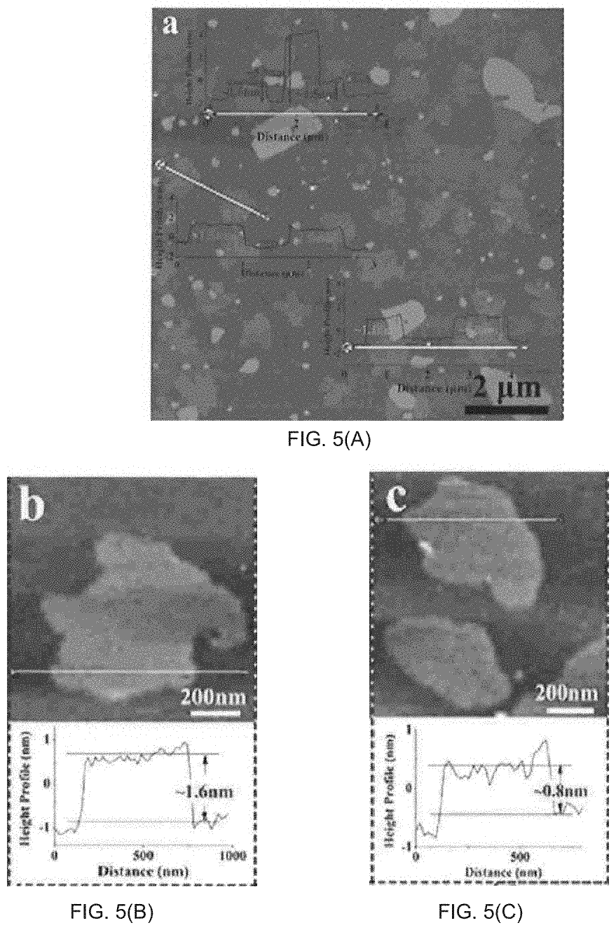

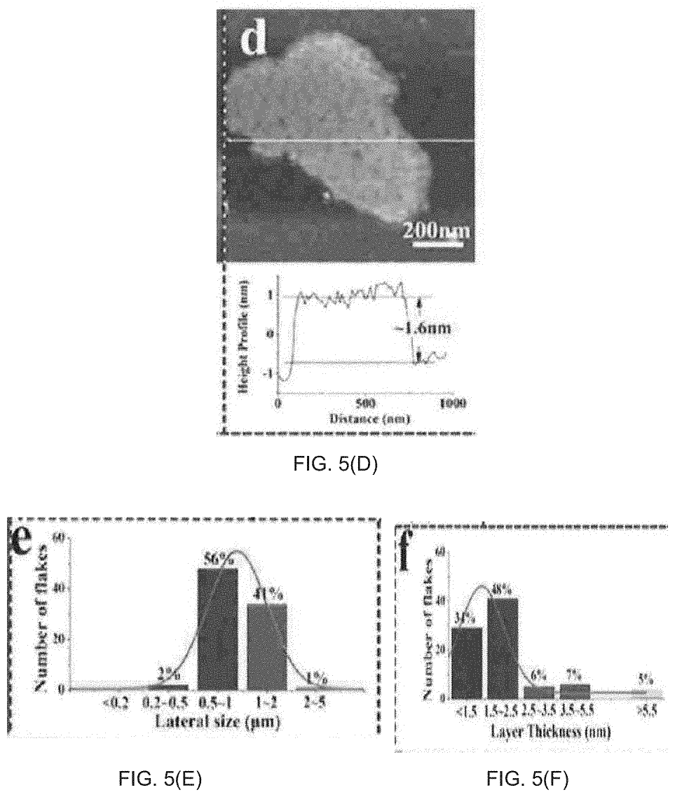

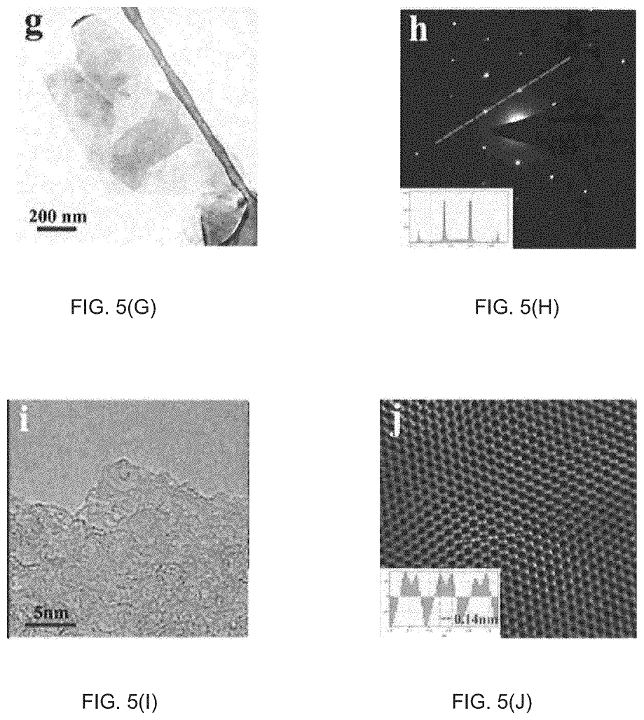

The well-exfoliated graphene layers dispersed in the supernatant were carefully decanted and subject to further characterization. FIG. 4 highlights the microstructure of AES-G. FIGS. 5(a)-5(f) show atomic force microscopy (AFM) analysis, which was employed to assess the geometrical features of the exfoliated material. It may be observed that the majority (82%) of graphene exhibits thicknesses less than 2.5 nm and a width of 1-2 μm. By statistically analyzing about 100 graphene flakes on a mica substrate, we observed 34% of them to be <1.5 nm and 48% of them to be 1.5-2.5 nm. The apparent height of monolayer graphene sheet probed by AFM is reported to be in the range from 0.8-1.5 nm, depending on the substrate, tip and measurement parameters, etc. Assuming a bilayer atomic structure with minimum porosity, the electrochemically active surface area of the material is on the order of 1325 m²/g (2630/2). Similarly, a pore-free graphene trilayer would be around 876 m²/g (2630/3). Such surface areas are on-par or higher than most 2D and 3D carbons employed for Na storage. It was observed that a majority of the graphene flakes exhibit thicknesses <2.5 nm. While IPS-G appears to be slightly thicker than AES-G, it possesses additional porosity inside the graphene sheets that is absent in AES-G. Therefore one may estimate its surface area to be on par, i.e. in the 876 m²/g-1325 m²/g range. An average width of the IPS-G flakes is significantly finer than that of AES-G, being 400 nm or less. AFM analysis reveals porosity in IPS-G, a structural feature not observed for the AES specimens. IPS-G was also determined to have a large number of nano-scale holes. The key structural aspects that contrast IPS-G to AES-G are the presence of significant mesoporosity and the low order per HRTEM and FFT. These features will become key for understanding stable versus unstable Na metal plating-stripping performance. According to Raman spectra, AES-G is highly ordered, showing an I_{G}/I_{D} ratio of 14.3. On the contrary, the IPS-G is much more disordered with a profound D peak, showing an I_{G}/I_{D} ratio of 1.61. The remnant IPS treated graphite is somewhat more defective as compared to the AES treated graphite, being indicative of the sonication wave impact angle.

X-ray Photoelectron Spectroscopy (XPS) was employed to investigate the near-surface chemistry of the exfoliated graphene. Both AES-G and IPS-G are free of impurities other than oxygen, however this is where there is a major difference between the two materials. The IPS graphene possesses an oxygen content on-par with prior reports of LPE exfoliated graphene, being measured at 6.2% of O (atomic percentage). This is mainly ascribed to oxygenated carbon (C—O/C═O) groups as indicated by O is spectra. However the AES-G is uniquely pure, being measured at 1.3% O.

Table 1 compares the thickness, order and oxygen content for AES and IPS graphene versus representative prior art for graphene exfoliated via a number of established methods, including “Classical” sonication (liquid phase exfoliation, LPE) which gives a random impingement angle of the sonication wave to the graphite.

TABLE 1
Geometry, structure and chemistry of AES-G and IPS-G as compared to prior state-of-the-art
graphenes prepared by various exfoliation methods, including prior sonication approaches.

| | | Order | Purity | |
|---|---|---|---|---|
| Graphene Synthesis | Thickness | (Raman | (Atomic | Chemicals employed for |
| Method | (AFM) | [symbol] | [symbol] | Synthesis |
| AES-G | Statistical | 14.3 | 1.3% O | None except solvent |
| | 82% < 2.5 nm | | | (NMP) |
| IPS-G | Statistical | 1.6 | 6.2% O | |
| Sonication LPE | Typical < | 1.0-3.3 | 8-25% O | Water/surfactant, organic |
| | 5 nm⁶ | | | solvent, ionic liquids, etc. |
| Electrochemical | Statistical | 2.38 | 5.5% O | (NH₄)₂SO₄, Na₂SO₄ |
| | | | (17.2) | |
| Electrochemical | Statistical | 4.3-6.7 | 6.6-8.4% O | (NH₄)₂SO₄, ascorbic acid/ |
| Exfoliation | 52% < 2 nm | | | hydrazine/NaBH₃/TEMP |
| Expansion-Sonication | Statistical | 11.1-50 | 3.4% O | CrO₃, HCl, H₂O₂, |
| Exfoliation | | | | |
| Intercalation | Typical | ~33 | 33% O | Potassium, pyridine |
| Exfoliation | 1-2 nm | | | |
| Bubble- | Typical | ~33 | 1.8% O | H₂SO₄, Na₂S₂O₈ |
| exfoliation | ~4.5 nm | | | |
| Expansion- | Statistical | ~5 | 16% O, | (NH₄)₂S₂O₈, |
| exfoliation | | | 2% S | H₂SO₄, oleum |
| Surfactant-assisted | Statistical | ~4 | Unspecified | Naphthalene dimide |
| Sonication-exfoliation | 6% < 1 nm | | | |
| Ionic-liquid assisted | Statistical | 7.14 | ~3% | Ionic liquid, DMSO |
| Microwave Exfoliation | 90% < 1 nm | | | |
| Polymer-assisted | Statistical | Unspecified | Unspecified | H₂SO₄ oleum, HI, |
| Exfoliation | 76% < ~10 nm | | | polymer |
| Hummer's method | Typical > | Typical ~1 | ~10% O | H₂SO₄, KMnO₄, |
| | 2 nm | | | |

*Statistical indicates a distribution was obtained, Typical means based on limited observations [symbol]
indicates data missing or illegible when filed

The AES-G specimens are on the average thinner, much more ordered, and possess significantly less oxygen impurities than traditional Hummer's method and LPE methods. The Raman and XPS indicate disordering of the graphene structure by the action of IPS, in agreement with previous reports where abundant edge-sites defects, topological defects, and oxygen functional groups were found to form due to sonication at random angles to the graphite flakes. Being measured at 1.3 at % oxygen and with no other detectable secondary elements, AES-G is close to ideal-graphene in its chemistry. It is also among the least defective, hence being close to ideal graphene in its order and bonding.

Ultrasound has been employed for a wide range of materials synthesis, including for exfoliating 2D structures. The exfoliation mechanism is established as arising from acoustic cavitation: the formation, growth, and collapse of bubbles in an ultrasound-irradiated liquids. Confocal points of a collapsing bubble (also known as micro-jets) will undergo extreme conditions with temperatures up to 5000 K and pressures of hundreds of bars, generating highly reactive species including radicals from sonolysis of the solvent vapor. These harsh condition create an oxidative environment (especially with trace H₂O and O₂), eroding the graphitic structure and forming topological defects, and oxygen functional groups (hydroxyl, carboxyl, epoxy, etc.). The ultrasonic micro-jetting was found to have a scissoring and fragmentation effect on carbon nanotubes and for graphene leading to a reduction of sp² order.

Based on the comprehensive structural and chemical analysis, a general sonochemical exfoliation mechanism can be proposed as follows: IPS induces shockwave micro-jets to impinge on the basal plane of graphite, resulting in severe damage to the hexagonal structure, nano-pore formation, and oxygen incorporation onto the surface and near surface sites. Conversely AES confines the micro-jets to hit the graphite edges, leading to delamination of intact graphene layers. When the sonication wave was parallel to the graphite basal planes, the above structural and chemical defects are largely avoided. This is due to the weak van der Waals bonding between the planes. When sonication wave is normal to the flake edge, it is able to freely separate the graphene sheets while incurring minimal damage to its structure. It should be noted that neither this experimental approach nor its mechanistic interpretation have been reported prior. Therefore, future experimental, analytical and modeling work is required to quantitatively understand the full exfoliation mechanisms in each case.

III. Electrochemical Measurements

Various carbons are perhaps the mostly widely used “templates” for plating/stripping studies in both Na and Li metal anode systems. High surface area carbon supports can reduce the true current density on the plating/stripping electrodes, serve as heterogeneous nucleation sites for the metal, and protect the formed metal interface from excessive interaction with the electrolyte. In these ways, carbons are known to reduce the degree of Na and Li dendrite growth. To quantitatively examine the role of graphene defectiveness on Na metal plating, binder-free AES-G and IPS-G electrodes were fabricated by drop-casting the graphene dispersions onto commercial Cu foils.

Binder-free electrodes were fabricated by identically drop-casting a dispersion of AES-G or IPS-G onto a standard Cu foil current collector, without any binders or carbon black. The loading of the graphene on the electrode was on the average 0.4 mg/cm², as measured by a microbalance (0.01 mg resolution, AUW120D, SHIMADZU). In order to clean the graphene from any residual solvent, the electrodes were heated at 400° C. for 1 h in an argon-filled tube-furnace.

The electrochemical performance of AES-G and IPS-G electrodes was measured in 2025-type coin cells. Sodium metal foils approximately 200 microns in thickness were employed as the counter electrodes. A standard research electrolyte of 1M NaClO₄ dissolved in 1:1 (volume ratio) mixture EC and DEC, with 5 vol. % fluoroethylene carbonate (FEC) was used. A Whatman glass fiber membrane was employed as a separator. The cells were assembled in an argon-filled glovebox with oxygen and moisture content lower than 0.1 ppm.

For the Na ion storage behavior tests and Na metal plating/stripping experiments, cycling tests were carried out using a LAND-CT2001A battery tester. Electrochemical impedance spectroscopy (EIS) tests were carried out using AUTOLAB M204 (Metrohm, Switzerland). Testing of both Na ion storage and Na metal plating was performed in a half-cell configuration, with a working electrode vs. Na metal. To analyze Na ion storage behavior, testing was done at a current density of 30 mA/g and a voltage range of 0.01V-2.5V vs. Na/Na⁺. The analysis of Na plating/stripping at 0 V vs. Na/Na⁺ was performed galvanostatically. Prior to the plating experiments, cells were “conditioned” by cycling several times at 30 mA/g through a voltage range of 0.01V-2.5V vs. Na/Na⁺, this process stabilized the carbon structure, largely eliminating any ambiguity from its contribution to early cycling irreversible capacity. Current density of 2 mA/cm² and 30 minutes deposition time were employed for Na plating/stripping experiments, corresponding to a total capacity of 1 mAh/cm². CE was defined as stripped Na metal capacity divided by the plated capacity from previous cycle. Since no “extra” reservoir of Na was used on the working electrode and the CE was less that 100%, the anodic voltage increased to the upper set limit of 1 V vs. Li/Li⁺ at desodiation. The absolute current accuracy of the LAND potentiostat is listed as 0.1% RD (read data)+0.1% FS (full scale). Therefore the “100%” CE is no less than 99.6% on account of the largest current deviation within instrument error range.

For both Na ion storage and plating experiments, the mass loading of the IPS-G and AES-G carbons was 0.4 mg/cm². After cycling, the electrodes were disassembled in a glove box and thoroughly rinsed with diethyl carbonate (DEC). This washed away the remnant electrolyte and soluble SEI, leaving behind an adherent coating of insoluble SEI. The cleaned and dried electrodes were then placed in argon filled seal bags held in an argon filled screw-bottle and transferred to SEM for analysis of the surface morphology.

The hypothesis of this study is that for Na metal anodes, it is the solid electrolyte interface (SEI) that dictates the plating/stripping behavior. In addition to other factors, SEI stability is generally considered important for stable Na and Li metal cycling. However, the true underappreciated implication of having SEI dominate 0 V vs. Na/Na⁺ plating/stripping is that the SEI formation on the actual template itself is extremely important. Reversible capacity loss during the initial cycles is primarily driven by the formation of a solid electrolyte interface (SEI) due to the irreversible reduction and chemical decomposition of the electrolyte. Since reduction of the solvent molecules to Na₂CO₃, Na alkyl carbonates and Na alkoxides consumes Na ions irreversibly, it leads to a concomitant CE loss. The SEI layer also possesses inorganic-based compounds such as Na₂O and NaF, which may be formed chemically or electrochemically. The AES and IPS graphenes are ideally suited to probe the interdependence among carbon structural and chemical defectiveness, SEI formation, and Na plating/stripping behavior. It is recognized that structural and chemical defects in a carbon will catalyze SEI formation on its surface. For instance, when more disordered graphitic carbons are tested as lithium ion battery anodes, CE loss and impedance rise at cycle 1 are worse. What is not known, however, is how structural and chemical defects affect the 0 V metal plating/stripping behavior when such carbons are employed as supports rather than the actual ion storage medium.

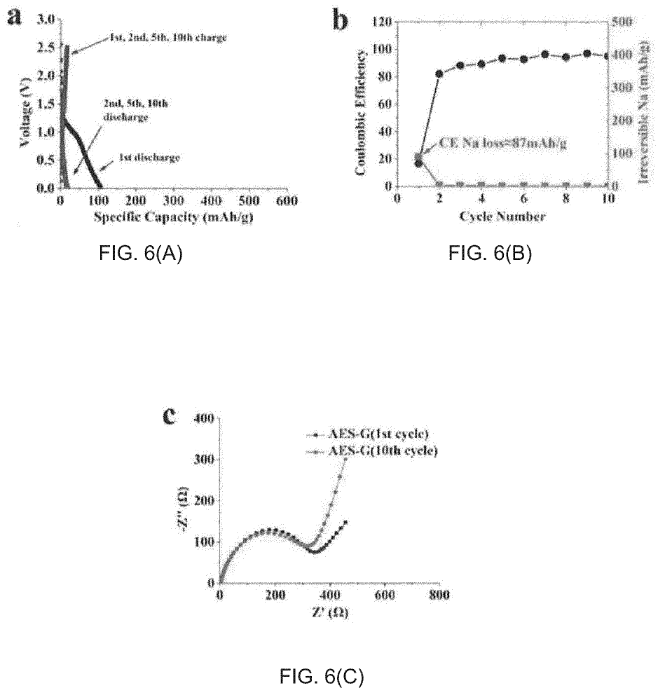

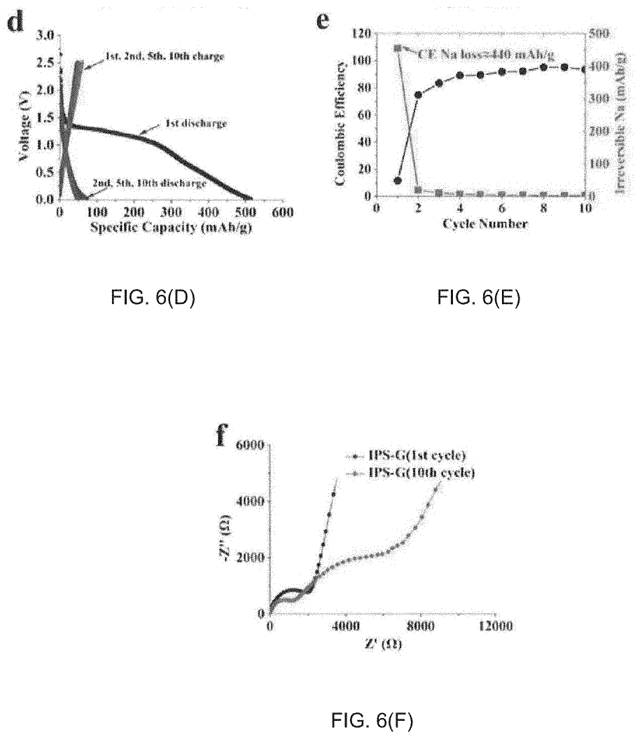

To understand the SEI formation process in these carbons per se, we tested them at 2.5-0.01 V vs. Na/Na⁺. This is a typical sodium ion battery anode (SIB) testing excursion, with the lower voltage cutoff being much above the equilibrium Na plating potential. However, SEI is thermodynamically stable below 0.8 V vs. Na/Na⁺ and will form on the carbon electrodes nevertheless. Through these “high voltage” tests, the intrinsic propensity for SEI formation of AES-G versus IPS-G may be better understood, since there is no Na metal in the working electrodes to further catalyze SEI growth and obscure the differences. Galvanostatic results of Na half-cells, as shown in FIGS. 6 (A)-6(F), show that the materials possess very different cycle 1 irreversible sodiation capacities, being near 100 mAh/g for AES-G and 500 mAh/g for IPS-G. Both AES-G (FIGS. 6 (A)-6(C)) and IPS-G (FIGS. 6 (A)-6(F)) exhibit low reversible capacity (<50 mAh/g), indicating that the materials are relatively “inert” to Na but form significant SEI. Due to IPS-G significant structural and chemical defect content, the SEI formation process is dramatically catalyzed.

Due to more SEI, IPS-G exhibits a much sharper increase in its impedance as compared to AES-G. The EIS frequency range was set at 0.1 Hz to 1 MHz, with an AC amplitude of 5 mV. EIS tests were performed in the sodiated state at 0.01V vs Na/Na⁺. Table 2 shows the fit results, highlighting the major differences between the two materials. Both at cycle 1 and at cycle 10, the AES-G demonstrates almost an order of magnitude lower impedance values. After 10 cycles the impedance values of AES-G are unaffected, while IPS-G nearly doubles in R_{CT} and develops a notable R_{SEI} component.

TABLE 2
Fitted EIS values for AES-G and IPS-G electrodes
after 1^{st} and 10^{st} galvanostatic charge - discharge
cycles between 2.5-0.01 V vs. Na/Na⁺.

| | | R_{f} |
|---|---|---|
| Sample | R_{ct} | (R_{SEI}) |
| AES-G | 366.4 Ω | NA |
| cycle 1 | | |
| IPS-G | 2488.2 Ω | NA |
| cycle 1 | | |
| AES-G | 339 Ω | NA |
| cycle 10 | | |
| IPS-G | 4200 Ω | 1130 Ω |
| cycle 10 | | |

Most likely the graphene serves a dual role in stabilizing the Na metal anode, it acts both as a nucleation template and as a protective layer to keep the metal from extensively contacting the electrolyte. As a dense template, the graphene's large surface area promotes uniform nucleation and dissolution of sodium crystallites during plating and stripping. Greater number of simultaneous nucleation sites in turn leads to a more planar metal-electrolyte front. Second, the graphene layers offers protection of the metal from the electrolyte, reducing the amount of Na-catalyzed SEI formation. Otherwise, even in the presence of AES-G, the Na metal would still be exposed to the fresh electrolyte at every cycle which would react just as severely as with the baseline Cu. The role of graphene as protection layer also explains the role of defects and surface oxygen in determining the CE loss, overpotential, and dendrite growth. To so drastically influence SEI formation, the graphene would need to be in direct contact with the electrolyte, else the OH groups and defects would matter little. The observation that the carbons' high voltage SEI formation propensity is directly correlated to the 0 V plating/stripping stability is critically important. Such link has not been reported prior in literature and may have a profound effect on the forward design strategy for a range of Na and Li metal templates.

Current densities of 2 mA/cm² and 30 minutes deposition time were employed, corresponding to a total capacity of 1 mAh/cm². It is observed that plating/stripping overpotential is significantly reduced from ˜200 mV for the bare Cu, to <20 mV for the Cu foil covered by AES-G. The foil covered by AES-G demonstrates far superior performance as compared to IPS-G. Severe voltage fluctuations are present in IPS-G as well as in the bare Cu, whereas AES-G remains stable throughout the testing. The voltage fluctuations are due to unstable SEI growth and an associated unstable Na metal front. There are points in the Cu and in IPS-G cycling profiles where the overpotential seems to drastically drop to what appears to be a stable value, with an associated 100% CE (within measurement accuracy). These events are attributed to intermittent electrical shorts due to Na dendrites, which lead to mixed electronic-ionic conduction. During ongoing cycling, the volume expansion associated with more SEI growth would open these shorts. This would lead to an increase in the overpotential again, and a low CE as conduction becomes purely ionic again. With the baseline Cu and with IPS-G, intermittent electrical shorts followed by opens are ongoing during cycling. Since the laboratory Na foils are relatively thick, this scenario goes on for many cycles. However, in “real” cells where the reservoir of available Na is much less, the capacity would fade as all the available ions become entrapped in the SEI.

IV. Detailed Experimental Procedure of AES-G and IPS-G Synthesis

Flake graphite powder (99.95%, metal basis, Aladdin Chemicals) was used as the graphene precursor. All chemical, including N-Methyl Pyrrolidone (NMP, 99.9%, Aladdin Chemicals), filter paper, etc. are received as is from Aladdin Chemicals.

The apparatus 100 shown in FIG. 2 was used for IPS/AES exfoliation. Disc-like particles are prone to align along the flow with respect to the strain velocity distribution due to elongation or/and shear strain. Governed by rheological laws, the suspended graphite platelets can be induced to align along the flow with respect to the slit geometry when flowing through the convergent slit. Simultaneous to the pump-driven cyclic flowing of suspension, sonication shockwave was imposed to the aligned particles with propagation direction perpendicular to the surface of the aligned graphite platelets or perpendicular to the edges of the aligned graphite platelets, denoted as “In-plane sonication” (IPS) or “At-edge sonication” (AES) respectively.

Regarding the design and control on the flow induced structures of AES-G and IPS-G, fluid dynamics are at the core of this methodology. Particles suspended in a fluid are prone to align with respect to shear strain when the strain energy associated with the flow overrules their thermal energy.

Based on flow dynamics, several factors such as viscosity of the suspension, characteristic dimension of graphite, and strain rate needs to be known to guide the random to orientated transition. As characterized by rotational rheometer and SEM analysis, the viscosity of the suspension is determined to be 1.91*10⁻³ Pa·s, and the average diameter of the graphite platelets is estimated to be 100 μm.

Given the uncompressible Newtonian fluid nature of the graphite/NMP suspension, the shear rate in the slit flow is only correlated with the volume flow rate and the slit geometry. Another factor to be considered when using a flow-device to induce particle orientation, is the transition of laminar flow to turbulent flow.

In a representative run, 2.4 g of graphite was dispersed in 80 ml NMP to form suspension, which was circulating pumped to flow through the slit 104. The width and height of the slit are 6 mm and 1 mm, respectively. Three 6 mm long slits with W=6 mm and H=1 mm were designed in parallel with respect to flow direction (as shown in FIGS. 1 and 1A). The volume flow was controlled at ˜4.5 m/s. Assuming even flow distribution in three slits, the flow velocity (V) was 0.25 m/s at each slit with a shear rate (\dot{γ}) 1500 s⁻¹. The Peclet number, Pₑ is calculated to be over ˜10¹⁰ indicating overwhelming dominance of the flow strain energy over the thermal energy, causing highly ordered graphite alignment in the slit. The Reynolds number Rₑ was 130 in the slit, giving fully laminar flow.

A 6 mm-diameter sonication probe (SCIENTZ-II, Ningbo Xinzhi Co.td) operating at 21-25 kHz was used to impose shockwaves to the oriented suspension. A pulsing sonication sequence of 20 s on followed by 10 s off was adopted to avoid overheating of the probe. The cycling flow device along with the sonicator were immersed in the water bath, which was monitored by a thermal couple and kept at room temperature. The dwell time (τ) of the suspension at every cycle in the slit was

$$τ = \frac{0.006 m}{0.25 m \text{/} s} = 0.024 s ,$$

and the suspension cycle time (t) was

$$t = \frac{80 ml}{4.5 ml \text{/} s} = 17.7 s .$$

Given that the suspension was subject to sonication shockwave for 0.024 s for each flow cycle (17.7 s), the actual sonication action time of the suspension can be calculated from the experimental sonication time (720 min) as

$$720 \times \frac{2}{3} \times \frac{0.024}{17.7} = 0.65 min .$$

After AES or IPS treatment, the suspensions were centrifuged (3000 rpm) for 15 min to isolate exfoliated flakes from remnant thick graphitic platelets.

Per Beer-Lambert law (UV-Vis absorption spectra), after a single synthesis run the graphene concentration is estimated to be 59 g/ml, which is achieved by applying 0.65 min of sonication. This is equivalent to 90 g/ml-min graphene production rate, which is on par with prior graphite liquid phase sonication exfoliation studies. The final graphene yield of a single run is estimated at 0.2 wt. % of the starting graphite precursor, also comparable with prior reports. While liquid phase exfoliation yields are intrinsically much lower than for reactive chemical-thermal methods such as Hummer's, they do have the inherent advantage of leaving the remnant material fully reusable. The un-exfoliated graphite is centrifugally separated and may be readily employed in the next fabrication run. The graphite may also be cycled for longer times within the flow loop reactor without process interruption, giving higher overall graphene yield. In principle, 100% of the graphite particles could be exfoliated into graphene, e.g. by extending the sonication time, replacing the dispersant, and re-cycling graphite residuals. The yield of graphene by sonication-based exfoliation method is dependent on sonication time, precursor characteristics, solubility of solvent and surfactant, etc.

TABLE 3
Fitted EIS values for AES-G, IPS-G and baseline Cu electrodes
after 1^{st} and 100^{st} plating/stripping cycles.

| Sample | R_{CT} cycle 1 | R_{CT} cycle 100 |
|---|---|---|
| AES-G | 387.7 Ω | 400.3 Ω |
| IPS-G | 353.9 Ω | 539.4 Ω |
| Bare-Cu | 1063.5 Ω | 4675.3 Ω |

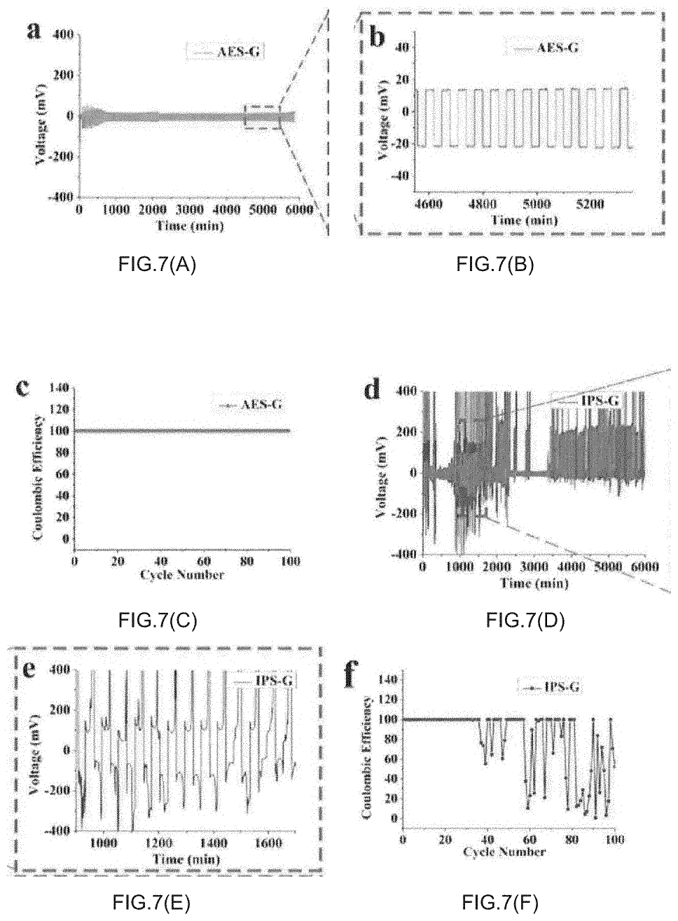

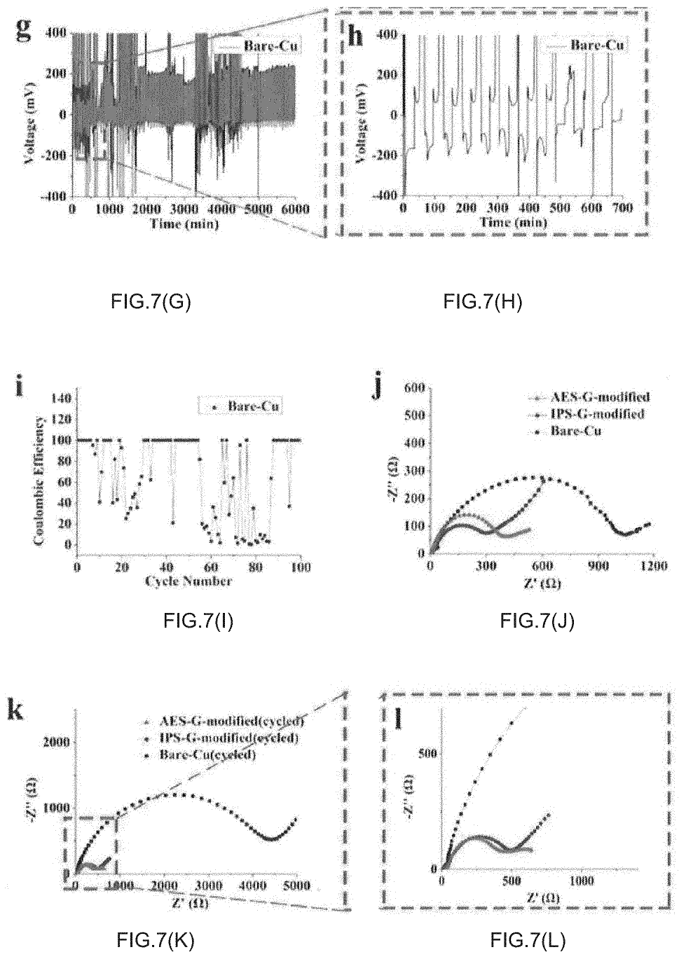

EIS analysis was conducted after cycle 1 and cycle 100 (6000 min total). EIS tests were performed in the fully stripped state at OCV. These Nyquist plots are shown in FIG. 7(j) at cycle 1 and 7(k, l) at cycle 100. For the plating/stripping behavior, it was not possible to mathematically separate the two semicircles in the Nyquist plots. The inventors termed the value R_{CT}, with the recognition that it accounts for the charge transfer resistances of the support-Na interface, the SEI resistance and the SEI—electrolyte interfaces. In fact, since the SEI is a complex composite of organic and inorganic phases, there are multiple internal interfaces within the SEI itself that contribute to the semicircle. At cycle 1, the bare Cu starts out with much higher R_{CT} than either of the graphene materials, a likely effect of the Cu foil being catalytic for SEI formation combined with a much higher true current density. At cycle 1, the R_{CT} values of AES-G and IPS-G are on-par. However, after 100 cycles, the R_{CT} for IPS-G goes up by over 50%, while the value for AES-G remains stable. As shown in Table 3, after 100 cycles, the R_{CT} for bare Cu more than quadruples, indicting major SEI growth.

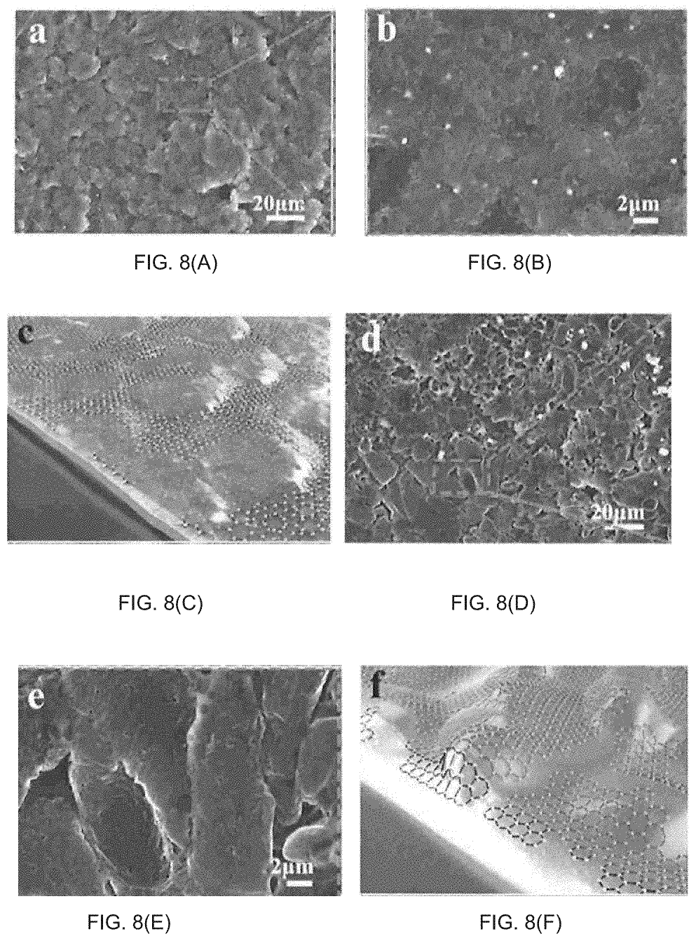

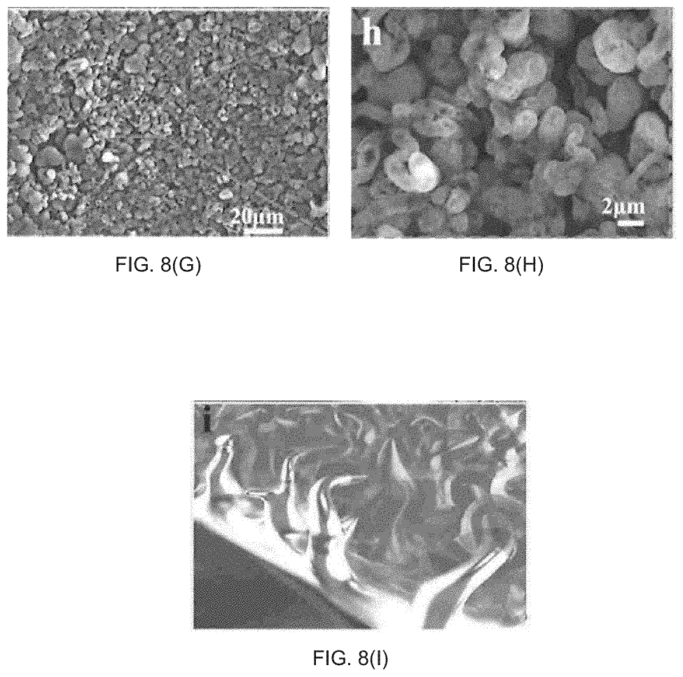

FIGS. 8 (A), 8(B), 8(D), 8(E), 8(G) and 8(H) show top-down SEM images of the fully plated electrode surfaces after the samples have underwent 100 cycles. In all cases the electrodes were washed removing remnant electrolyte but remained covered by the solid SEI layer, which was quite stable during cleaning. FIGS. 8(G) and 8(H) show the results of the Na metal deposited on the bare Cu foil. The metal front, which is covered by SEI, exhibits coarse “mossy” dendrite morphologies with branches having diameters in 1-2 μm range. Since the SEI has a finite thickness to it, one can assume that the actual metal branches are finer. For the bare Cu, the overall electrode surface morphology is consistent with previous studies. Over multiple cycles, preferential metal deposition on protuberances and defects in the current collector are favored. An SEI layer is by its nature heterogeneous, leading to accelerated non-uniformity in the growth process. While preferred nucleation sites for Na metal remain to be established, it is likely that certain SEI-Cu interfaces are preferred. This could be for example regions where the SEI is inorganic, such as Na₂O or NaF. It is also expected that the Na flux to the Cu current collector through the various SEI phases, and through their interfaces, will also be anisotropic. This will lead to preferred regions where Na metal accumulates or dissolves, ultimately leading to a large number of mossy dendrites.

The role of the graphene defectiveness and chemistry in promoting stable Na plating may be further understood by comparing FIGS. 8(A) and 8(B) AES-G versus FIGS. 8(D) and 8(E) IPS-G. The topography of the post-cycled AES-G specimen is relatively uniform, while that of IPS-G is rough indicative of dendrite growth. The surface area of AES and IPS graphenes is on-par, both in the as-fabricated state and in the final electrodes. A difference in the two graphenes is their structural defectiveness (nanopores, graphitic order) and chemical defectiveness (O content). As is demonstrated, this leads to differences in the SEI levels that then affected metal growth/shrinkage during cycling. A schematic cross-section of the three materials is provided in FIG. 8 (c, f, i). As shown in FIG. 8(F) the excessive SEI in IPS-G also likely leads to increased levels of “dead Na”, i.e. that is electrically isolated due to being encapsulated by the SEI layer. Dead Na should likewise be extensively present in the bare Cu, but to a much lesser extent in AES-G per the measured CE values.

The inventors ascribe the distinction of Na-metal plating behavior to the inherently different propensity of SEI formation of AES-G and IPS-G.

The SEM secondary electron images of the AES-G and IPS-G surface topography can be compared to the maps of F, Na, O and C elemental distributions. There is good evidence for reduction of FEC to NaF within the SEI layer, per the relatively strong (˜1.5 at %) EDXS signal combined with the XPS F peaks. The SEM EDXS fluorine F map of the SEI covering IPS-G has arrows to highlight the F-rich regions within the layer. Conversely, the F map of AES-G is uniform with no obvious F-rich regions. The root cause of the aggregated F in IPS-G remains to be fully understood. However, one may qualitatively argue that the NaF-rich “hot spots” correlate to local regions where dendrite growth and/or carbon defects catalyze accelerated decomposition of the additive. One could further surmise that since FEC's known role is to stabilize the structure of the SEI, the localized F-rich regions are where SEI formation is accelerated. The compounds NaF and LiF are ion-permeable and solvent-proof, being an essential SEI component needed for compact and uniform Li/Na deposits. The FEC concentration in solution is finite, being 5 vol. % in this study. An unstable SEI layer would then be self-amplifying, as FEC in solution becomes exhausted due to ongoing formation of NaF compound. This further helps to explain the core difference between AES-G and IPS-G: The structure/chemistry of IPS-G may drive the essential FEC additive to exhaustion much sooner than for AES-G. Baseline Cu also yields an unstable SEI, which likewise exhausts FEC prematurely during cycling.

2. Synthesis of r-GO and Comparison of d-GO and AES-G

I. Synthesis of Reduced Graphene Oxide (r-GO)

Sulfuric acid, sodium nitrate, and potassium permanganate were used as oxidants to yield graphene oxide from pristine graphite. Typically, 0.2 g graphite was firstly mixed with 0.1 g sodium nitrate and 5 ml concentric sulfuric acid in a reaction flask, keeping constant stirring within an ice-water bath. Then, 0.5 g potassium permanganate was added step-wise to the blended solution until proper uniform dissolution. The oxidation reaction was kept under constant stirring and cooling at 0 degree centigrade (changing ice) for 1 h. After oxidation reaction, 30 ml of deionized water was added slowly followed by 10 ml of hydrogen peroxide (30%) to reduce the residual permanganate to soluble manganese ions so there will be minimal metal ion contaminates in the graphene oxide (GO) layers.

Repeated rinsing and filtration was adopted to eliminate possible contaminates from residual chemicals, the GO suspension was then subject to 2 h of bath-sonication to exfoliate GO layers. After centrifuging at 3000 rpm for 15 min to remove un-exfoliated flakes, the GO suspension reaction flask was transferred to a 80° C. water bath, then 1 ml of hydrazine monohydrate solution (40 wt %) was added through injection. The black precipitates were collected and then washed and filtrated copiously before freeze-drying to give r-GO powder, which was transferred into a furnace for further thermal reduction (800° C., under argon flow). We note a chemical-thermal dual reduction protocol (hydrazine chemical reduction followed by 800° C. thermal reduction) was adopted here to yield Hummers method r-GO sheets with the lowest-possible defects and heteroatoms, in parallel with previous reports.

II. Synthesis of Lithium Plating Templates

Lithium plating templates were fabricated by drop-casting dispersion of AES-G or r-GO onto a standard Cu foil current collector, without any binders or carbon black. Typical loading was 0.4 mg/cm² (0.01 mg resolution microbalance, AUW120D, SHIMADZU). To understand the SEI formation tendencies of both materials, Li storage (not plating) experiments were also performed. To clean the graphene from any residual solvent prior to cell assembly, the electrodes were heated at 400° C. for 1 h in an argon-filled tube-furnace. Lithium-graphene cells were assembled using 2025-type coin cells. Assembly was done in an argon-filled glovebox with O and H₂O below 0.1 ppm. The Li metal foils were approximately 800 microns thick, purchased from China Energy Lithium Co., Ltd. A standard research-grade electrolyte of 1M LiPF₆ dissolved in 1:1:1 (volume ratio) mixture of ethylene carbonate (EC), ethyl methyl carbonate (EMC) and diethyl carbonate (DEC), with 5 vol. % FEC was used. Some baseline Cu current collector-Li metal cells were also tested without the FEC additive. All electrolyte chemicals were purchased from Energy Chemicals and employed in their as-received state. Cellgard 2400 was employed as separator. Lithium metal plating/stripping and storage experiments were done employing a LAND-CT2001A test system. Electrochemical impedance spectroscopy (EIS) analysis was performed with an AUTOLAB M204 (Metrohm, Switzerland). After 100 cycles the 2025 cells were disassembled in a glovebox and cleaned with diethyl carbonate (DEC). This removed the remaining electrolyte and any soluble SEI products, leaving behind an adherent coating of insoluble SEI on the plated Li metal. The dried electrodes were double protected in argon filled seal bags placed inside argon filled screw-bottles, minimizing air exposure during transfer to the SEM.

III. Characterization and Electrochemical Measurements of AES-G and r-GO

Near surface chemistry characterization was based on X-ray photoelectron spectroscopy (XPS). ThermoFisher EScalab 250Xi XPS system with Al Kα radiation was employed. Peak fitting was performed using Gaussian/Lorentzian peak shapes following subtraction of Shirley background. Structural order in the graphenes was investigated using Raman spectroscopy, done using a Horriba LabRAM HR, equipped with a 532 nm laser. Graphene morphology was analyzed by scanning electron microscopy (SEM), using a JSM-7500F Field Emission SEM operated at 15 kV. Thickness and morphology were further analyzed using atomic force microscopy (AFM). AFM was performed out in tapping mode in Bruker Multimode 8. AFM specimens were fabricating by dispersing a drop of graphene ink onto freshly cleaved mica substrate. Structure and morphology was analyzed by transmission electron microscopy (TEM). A Tecnai G2-F20 TEM operated at 200 kV was employed. Several drops of the graphene dispersion were deposited onto a lacey carbon mesh grid to fabricate specimens. N₂ adsorption/desorption analysis was carried out by Micromeritic ASAP 2460 at 77K, the Branauer-Emmett-Teller (BET) method was used to calculate the specific surface area. The pore size distribution was calculated based on slit/cylindrical non-linear density function theory (NLDFT) model.

To eliminate any possible side effect of binder or conductive filler, binder-free electrodes were prepared by drop-casting dispersions of df-G (AES-G) or r-GO onto Cu foil current collector without any binders or carbon black. The mass loading of the graphene on the electrode was on the average 400 g, as measured by a microbalance (10 g resolution, AUW120D, SHIMADZU). In order to clean the graphene from any residual solvent, the electrodes were heated at 400° C. for 1 h in an argon-filled tube-furnace. The electrochemical performance was measured in 2025-type coin cells, using lithium metal foils (800 microns thick, China Energy Lithium Co., Ltd) as the counter electrodes. 1 M LiPF₆ dissolved in a 1:1:1 (volume ratio) mixture of ethylene carbonate (EC), ethyl methyl carbonate (EMC) and diethyl carbonate (DEC) was used as electrolyte, 5 vol. % FEC was used as SEI enhance component (in the baseline electrode, no FEC was used as indicated). A Celgard 2400 membrane was employed as a separator. The cells were assembled in an argon-filled glovebox with oxygen and moisture content lower than 0.1 ppm.

For the Li ion storage behavior tests and Li metal plating/stripping experiments, cycling tests were carried out using a LAND-CT2001A battery tester. Electrochemical impedance spectroscopy (EIS) tests were carried out using AUTOLAB M204 (Metrohm, Switzerland). Frequency range was set at 0.1 Hz˜1 MHz with an AC amplitude of 5 mV. All Nyquist plots were fitted and then normalized to zero starting point, to better highlight changes of charge transfer resistance and SEI resistance. To analyze Li ion storage behavior, testing was done at a current density of 100 mA/g and a voltage range of 0.01V-3V vs. Li/Li⁺. Prior to the Li metal plating/stripping (0 V, theoretical) experiments, cells were cycled several times at 100 mA/g through a voltage range of 0.01V-3V vs. Li/Li, to stabilize the carbon structure and allow the formation of initial SEI film. After plating cycles, electrodes were disassembled in a glove box and thoroughly rinsed with diethyl carbonate (DEC). This washed away the remnant electrolyte and soluble SEI, leaving behind an adherent coating of insoluble SEI. The cleaned and dried electrodes were then placed in argon filled seal bags held in an argon filled screw-bottle and transferred to SEM for analysis of the surface morphology.

The r-GO in the current study is similar in structure to prior reported r-GO. In fact, it possesses slightly lower defectiveness and heteroatom content compared to prior studies. To contrast, the df-G exhibits unique structural integrity with extremely low heteroatom content for a “wet” synthesized graphene material. Comparison of df-G (AES-G) and r-GO is found in Table 4.

TABLE 4
Geometry, structure and chemistry of AES-G and IPS-G as compared to prior state-of-the-art
graphenes prepared by various exfoliation methods, including prior sonication approaches.

| | | | Heteroatoms | Chemicals |
|---|---|---|---|---|
| Graphene Synthesis | Thickness | Defectiveness | (Atomic | involved during |
| Method | (AFM) | (Raman I_{G}:I_{D}) | percentage) | Synthesis |
| df-G (current study) | ≤2.5 nm | 0.07 | 1.3% O | solvent (NMP) |
| r-GO (current study) | 10 nm | 0.89 | 8.1% O, | H₂SO₄, KMnO₄, |
| | | | 1% N&S | Na₂NO₃, |
| | | | | hydrazine, H₂O₂ |
| | | | | H₂SO₄, KMnO₄ |
| Hummer's method | Typical > | Typical ~1 | ~10% O | hydrazine/NaBH |
| Exfoliation | 2 nm | | | Water/surfactant, |
| Sonication LPE | <5 nm^{[2]} | 0.3-1 | 8-25% O | organic solvent, |
| | | | | ionic liquids, etc. |
| Electrochemical | 2~3 nm | 0.14-0.42 | 5.5%-8.4% O | (NH₄)₂SO₄, |
| Exfoliation | | | | Na₂SO₄ |
| | | | | K₂SO₄ |
| Expansion-exfoliation | Statistical | ~0.2 | 16% O, | (NH4)S₂O₈, |
| | mean 25 nm | | 2% S | H₂SO₄, oleum |
| Ionic-liquid assisted | Statistical | 0.15 | ~3% | Ionic liquid, |
| Microwave Exfoliation^{[18]} | 90% < 1 nm | | | DMSO |
| Intercalation Exfoliation | ~2 nm | ~0.03 | 3.3% O | Potassium, |
| | | | | pyridine |
| Bubble-exfoliation | Typical ~4.5 nm | ~0.03 | 1.8% O | H₂SO₄, Na₂S₂O₈ |
| Polymer-assisted | Statistical | Unspecified | Unspecified | H₂SO₄, oleum, |
| Exfoliation^{[21]} | 76% < ~10 nm | | | HI, polymer |

As will be apparent to those skilled in the art, various modifications, adaptations and variations of the foregoing specific disclosure can be made without departing from the scope of the invention claimed herein. The various features and elements of the invention described herein may be combined in a manner different than the specific examples described or claimed herein without departing from the scope of the invention. In other words, any element or feature may be combined with any other element or feature in different embodiments, unless there is an obvious or inherent incompatibility between the two, or it is specifically excluded.

References in the specification to “one embodiment,” “an embodiment,” “aspect”. “example” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about”. The term “about” can refer to a variation of 5%, 10%, 20%, or 25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by the skilled artisan, all numbers, including those expressing quantities of reagents or ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. A stabilization material for an energy storage device, the material comprising:
defect-free graphene.

2. The stabilization material according to claim 1, wherein the defect-free graphene comprises a maximum O content of 2.0 at. %.

3. The stabilization material according to claim 1, wherein the defect-free graphene is up to three layers thick.

4. The stabilization material according to claim 1, wherein the defect-free graphene further comprises a Raman G/D band intensity ratio of at least 10.

5. The stabilization material according to claim 1, wherein the material is applied to an electrode or a separator of the energy storage device.

6. The stabilization material according to claim 5, wherein the material is applied to the separator.

7. The stabilization material according to claim 5, wherein the electrode is an anode or a cathode.

8. The stabilization material according to claim 1, wherein content of defect-free graphene is at least 50% of the stabilization material.

9. The stabilization material according to claim 8, wherein content of defect-free graphene is at least 80% of the stabilization material.

10. A method of stabilizing an energy storage device, the method comprising:
providing an energy storage device comprising at least one electrode and a separator; and
applying a stabilization material according to claim 1 to an electrode or a separator, wherein the stabilization material is applied in an amount sufficient to: prevent or minimize dendrite formation or growth during cycling; stabilize an electrode/electrolyte interphase; or stabilize solid electrolyte interphase (SEI).

11. The method according to claim 10, wherein the stabilization material is applied to the separator.

12. The method according to claim 10, wherein the stabilization material is applied to the electrode.

13. The method according to claim 12, wherein the electrode is a cathode or an anode.

14. A method for synthesizing defect-free graphene, the method comprising:
providing a graphene precursor to a flow-aided sonication apparatus, the graphene precursor comprised of particulates, wherein the flow-aided sonication apparatus comprises:
a flow channel positioned along an axis, the flow channel having a first opening and a second opening, the second opening opposite of the first opening, wherein the graphene precursor enters the flow channel through the first opening;
aligning edges of the particulates parallel to axis A; and
imposing sonication shockwave to the edges of the aligned particulates of the graphene precursor, wherein the sonication shockwave is imposed to the graphene precursor in a propagation direction perpendicular to the edges of the particulates such that planes of the sonication shockwave are parallel to the edges of the particulates, thereby synthesizing defect-free graphene.

15. The method according to claim 14, further comprising:
suspending the graphene precursor in a solvent.

16. The method according to claim 15, wherein the solvent is N-methyl pyrrolidone.

17. The method according to claim 14, wherein the graphene precursor is selected from the group consisting of graphite, hemp and cannabis.

18. The method according to claim 17, wherein the graphite is graphite powder.

19. The method according to claim 14, further comprising:
collecting the graphene precursor and defect-free graphene exiting the second opening of the flow channel;
centrifuging the collected graphene precursor and defect-free graphene; and
isolating the defect-free graphene from the graphene precursor.

20. An electrode comprising: a defect-free graphene.
